(19) United States
(12) Patent Application Publication
(10) Pub. No.: US 2016/0326792 A1
(43) Pub. Date: Nov. 10, 2016

(54) HIDDEN SAFE SYSTEM

(71) Applicant: Timothy Matthew Hjort, Ashburn, VA (US)

(72) Inventor: Timothy Matthew Hjort, Ashburn, VA (US)

(21) Appl. No.: 14/707,920

(22) Filed: May 8, 2015

(51) Int. Cl. E05G 1/04; E05G 1/024; E05B 65/00; E05G 1/026

(52) U.S. Cl. CPC E05G 1/04; E05G 1/026; E05G 1/024; E05B 65/0075; E05G 2700/02

(57) ABSTRACT

A hidden safe system includes a safe and rails for attaching the hidden safe system to a structure. The rails are attached to the safe so that the safe is contained within the structure. The rails also include attachment devices to attach a covering to the rails. The rails allow the covering to be moved to cover the safe or to revel the safe for use.

### BACKGROUND

Home security is an important consideration for homeowners. Many homeowners maintain firearms or other weapons for personal and home security. This, however, introduces issues with safety in the household. Homeowners often desire to securely store firearms so that they are not accessible to children or intruders. To secure firearms, homeowners maintain safes or lockboxes to store firearms and weapons. These safes or lockboxes, however, are not easy to access quickly. Also, these safes or lockboxes do not provide an ascetically pleasing appearance that matches existing decorations in a home.

As such, there is a need for a safe system that securely stores firearms or other items while providing quick and easy access to the safe and providing an ascetically pleasing appearance.

### BRIEF DESCRIPTION OF THE DRAWINGS

Various features of the implementations can be more fully appreciated, as the same become better understood with reference to the following detailed description of the implementations when considered in connection with the accompanying figures, in which:

FIGS. 1A-1B, and 1C illustrates an example of a hidden safe system, according to various implementations of the present disclosure;

FIGS. 2A and 2B illustrate another view of the hidden safe system, according to various implementations; and

FIG. 3 illustrates a view of a wall in which the hidden safe system can he installed, according to various implementations.

### DETAILED DESCRIPTION

For simplicity and illustrative purposes, the principles of the present teachings are described by referring mainly to examples of various implementations thereof. However, one of ordinary skill in the art would readily recognize that the same principles are equally applicable to, and can he implemented in, all types of information and systems, and that any such variations do not depart from the true spirit and scope of the present teachings. Moreover, in the following detailed description, references are made to the accompanying figures, which illustrate specific examples of various implementations. Electrical, mechanical, logical and structural changes can be made to the examples of the various implementations without departing from the spirit and scope of the present teachings. The following detailed description is, therefore, not to be taken in a limiting sense and the scope if the present teachings is defined by the appended claims and their equivalents.

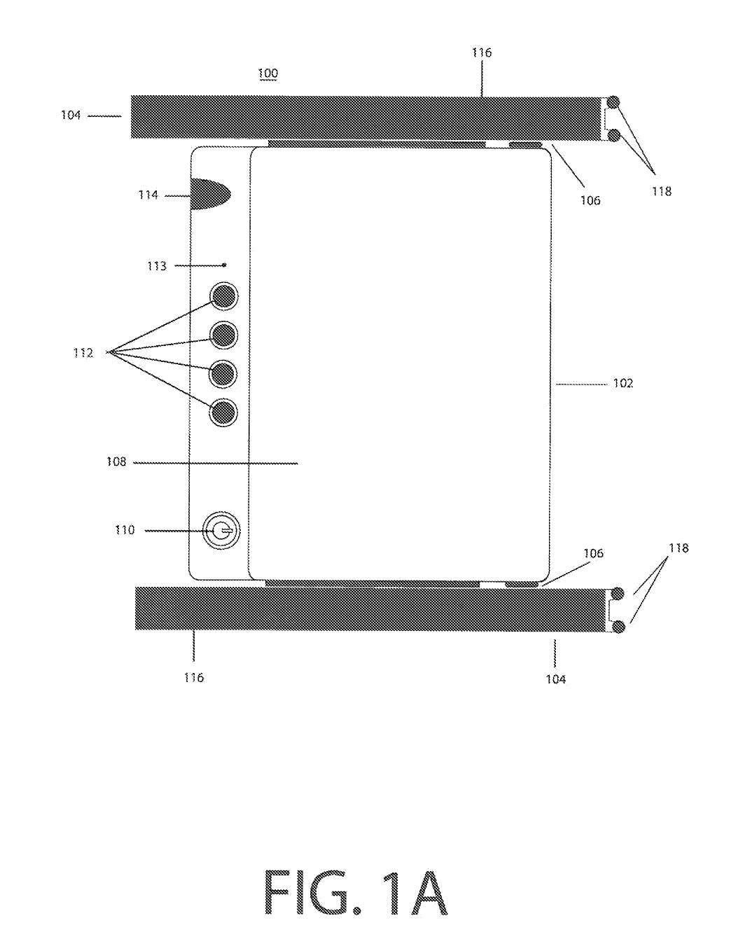

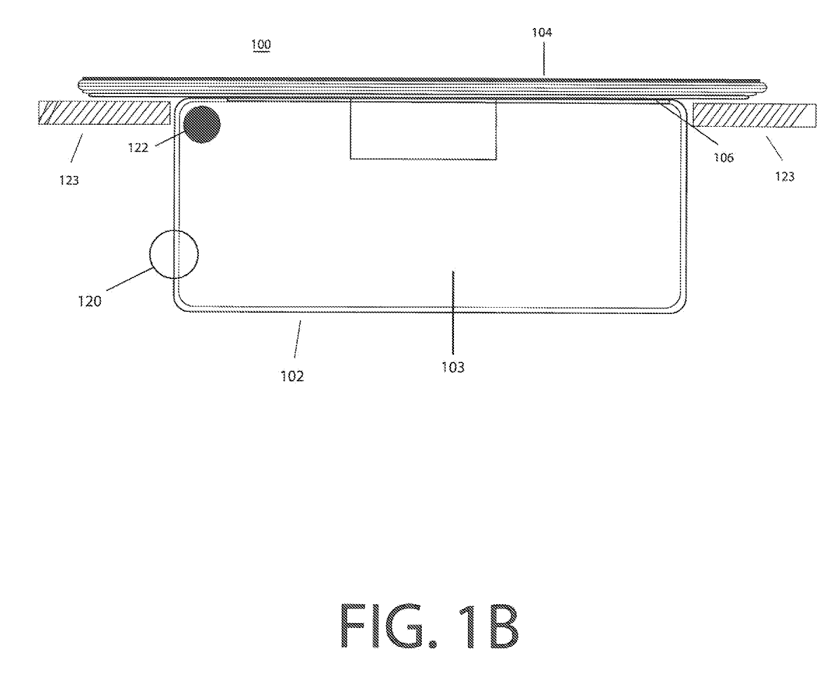

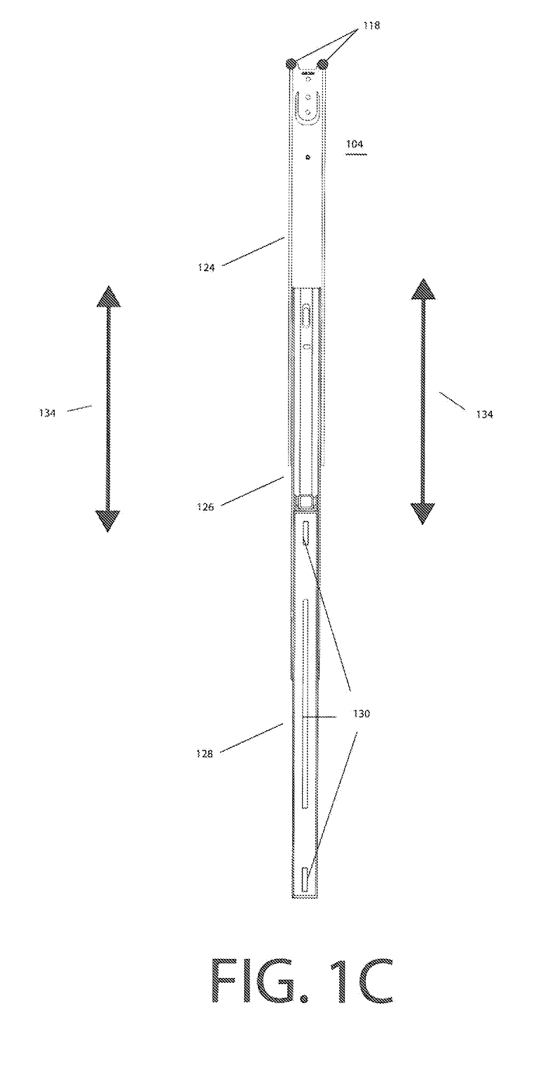

FIGS. 1A, 1B and 1C illustrate an example of a hidden safe system 100, according to various implementations. While FIGS. 1A and 1B illustrate various components contained in the hidden safe system 100. FIGS. 1A and 1B illustrate one example of a hidden safe system and additional components can be added and existing components can be removed.

FIG. 1A illustrates a front view of the hidden safe system 100. FIG. 1B illustrates a top view of the hidden safe system 100. As illustrated in FIG. 1A, the hidden safe system 100 can include a safe 102 and a pair of sliding rails 104. The pair of sliding rails 104 can be coupled to the safe 102 by brackets 106. The brackets 106 can be attached to the safe 102 by any mechanical device or process, for example, screws, bolts, nuts, rivets, welding, etc.

The safe 102 can include, a door 108. As illustrated in FIG. 1B, the safe 102 can include a housing 120. The housing 120 of safe 102 can form a compartment 103 for securely storing items. A hinge 122 can be coupled to the safe 102 and the door 108. The hinge 122 can he attached to the safe 102 and the door 108 by any mechanical device or process, for example, screws, bolts, nuts, rivets, welding, etc. The hinge 122 can be configured to allow door 108 to open to provide access to an interior of the safe 102 and the compartment 103. The safe 102 and the housing 120 of the safe 102 can be formed on any material that prevents access to the safe 102. For example, the safe 102 and the housing 120 of the safe 102 can be formed of metal, metal alloys, composite materials, and the like.

In implementations, as illustrated in FIG. 1B, the pair of sliding rails 104 can be coupled to the safe 102, by the brackets 106, so that the safe 102 can be hidden in a wall or other structure 123. The pair of sliding rails 104 can be coupled to the safe 102 such that a front surface of the safe 102 is approximately flush with a rear surface of the sliding rails 104. For example, the pair of sliding rails 104 can be coupled to the safe 102 such that a front surface of the safe 102 is approximately 1/16 of an inch or less in spacing from the rear surface of the pair of sliding rails 104. When installed, the pair of sliding rails 104 can be positioned to be approximately flush with an outer surface of a wall or other structure 123. As such the front surface of the safe can be approximately flush with or recessed from the outer surface of the wall or other structure 123. The remaining housing 120 and compartment 103 can be contained within the wall or other structure 123.

Returning to FIG. 1A, the safe 102 can include a locking mechanism and one or more access systems to actuate the locking mechanism. The locking mechanism can be configured to secure the door 108 and prevent the door from opening unless an unlocking procedure is performed. The one or more access systems can be configured to receive access devices, information, and/or tokens, from a user, in order to actuate the locking mechanism. While FIG. 1A illustrates several access systems, the safe 102 can include any number of access systems.

In some implementations, the one or more access systems can include a key lock 110. The key lock 110 can be configured to receive a key to actuate the locking mechanism in order to unlock the door 108. When the key is inserted into the key lock 110 and turned a first direction (e.g. clockwise), the locking mechanism can be actuated, and the door 108 can be unlocked. When the key is turned a second direction (e.g. counter clockwise), the locking mechanism can be actuated, and the door 108 can be locked. The key lock 110 can include the necessary mechanical, electrical, and/or electromechanical devices to allow the key lock 110 to actuate the locking mechanism.

in some implementations, the one or more access systems can include a key pad 112 and a passcode light 113. The key pad 112 can be configured to receive a passcode to actuate the locking mechanism in order to unlock the door 108. When the passcode is entered into the key pad 112, the locking mechanism can be actuated, and the door 108 can he unlocked. When one or more keys of the keypad 112 are pressed, the locking mechanism can be actuated, and the door 108 can be locked. The passcode light 113 can be configured to provide a visual indication that the correct passcode was entered. For example, the passcode light 113 can be configured to emit a first colored light that indicates the passcode is being entered and emit a second colored light that indicates a correct passcode was entered. The key pad 112 and the passcode light 113 can include the necessary mechanical, electrical, and/or electromechanical devices to allow the key pad 112 to receive and verify a passcode to actuate the locking mechanism. The key pad 112 and the passcode light 113 can also include the necessary mechanical, electrical, and/or electromechanical devices to allow the key pad 112 to be programmed with a passcode.

In some implementations, the one or more access systems can include a biometric scanner 114. The biometric scanner 114 can be configured to receive biometric information to actuate the locking mechanism in order to unlock the door 108. For example, the biometric information can include a fingerprint, a voiceprint, a retinal print, and the like. When the biometric information is detected by the biometric scanner 114, the locking mechanism can be actuated and the door 108 can be unlocked. When the biometric information is detected by the biometric scanner 114, the locking mechanism can be actuated and the door 108 can be locked. The biometric scanner 114 can include the necessary mechanical, electrical, and/or electromechanical devices to allow the biometric scanner 114 to detect and verify the biometric information, to actuate the locking mechanism. The biometric scanner 114 can also include the necessary mechanical, electrical, and/or electromechanical devices to allow the biometric scanner 114 to be programmed to receive biometric information of a user.

In implementations, the pair of sliding rails 104 can be configured to receive a covering. The covering can be any item to cover the hidden safe system 100. For example, the covering can be a picture, a painting, a screen, and the like. Each of the sliding rails 104 can include an attaching device 116. The attaching device 116 can allow a covering to be attached the pair of sliding rails 104 and removed from the pair of sliding rails 104. The attaching device 116 allows a user to personally select the covering that will hide the hidden safe system 100. Additionally, the attaching device 116 allows existing decoration in a home or office to be used with the hidden safe system 100.

In some implementations, for example, the attaching device 116 can include hook and loop material, e.g. VELCRO, that allows the covering to be attached to and removed from the pair of sliding rails. In this example, the loop material can he attached to the sliding rail 104 and hook material can be attached to the covering, or visa versa. The hook material and loop material can be mated to attach the covering to the pair of sliding rails 104. In some implementations, for example, the attaching device 116 can include one or more mechanical attachment devices such as screws, bolts, nuts, rivets, etc.

In implementations, each of the sliding rails 104 can be configured to allow a front surface of each of the sliding rails 104 to move parallel relative to a back surface of each of the sliding rails 104. FIG. 1C illustrates a rear view of one of the sliding rails 104. For example, as illustrated in FIG. 1C, the sliding rail 104 can include a stationary arm 128 and telescoping arms 126 and 124. The stationary arm 128 can include one or more openings 130. The openings 130 can be configured to receive attaching devices (e.g. screws, nails, bolts, etc.) to allow the stationary arm 128 to be attached to the wall or other structure 123 and/or components of the wall or other structure 123 (e.g. studs, frames, etc.) As illustrated, the openings 130 can extend lengthwise along the stationary arm 128 to allow the stationary arm to be positioned and repositioned once attach to the wall or other structure 123.

In implementations, the telescoping arms 126 and 124 can be configured to move parallel in a direction 134 relative to the stationary arm 128. The telescoping arm 126 can be formed to a width larger than the stationary arm 128. When the telescoping arm 126 moves in the direction 134, the telescoping arm 126 can slide over the stationary arm 128. The telescoping arm 124 can be formed to a width larger than the telescoping arm 126. When the telescoping arm 124 moves in the direction 134, the telescoping arm 124 can slide over the telescoping arm 126 and the stationary arm 128. In some implementations, for example, the stationary arm 128, the telescoping arms 124 and 128 can be approximately 16 inches when collapsed in the un-telescoped position and can be approximately 32 includes when extended in the telescoped position.

In some implementations, the stationary arm 128 can include a locking mechanism. The locking mechanism can be configured to lock the telescoping arms 124 and 126 into a stationary position over the stationary arm 128 until a force is applied to the telescoping arm 124 and 126. The locking mechanism can also be configured to allow one or both of the telescoping anus 124 and 126 to be decoupled from the stationary arm 128. The one or both of the telescoping arms 124 and 126 to be decoupled to allow a user to attach the covering to the telescoping arm 124. The sliding rail 104 can also include ball bearing or other devices to assist in the motion of the telescoping arms 124 and 126. The sliding rails 102 can also include one or more pads 118, for example, felt pads. The one or more pads 118 can prevent damage to the wall or other structure 118 during motion.

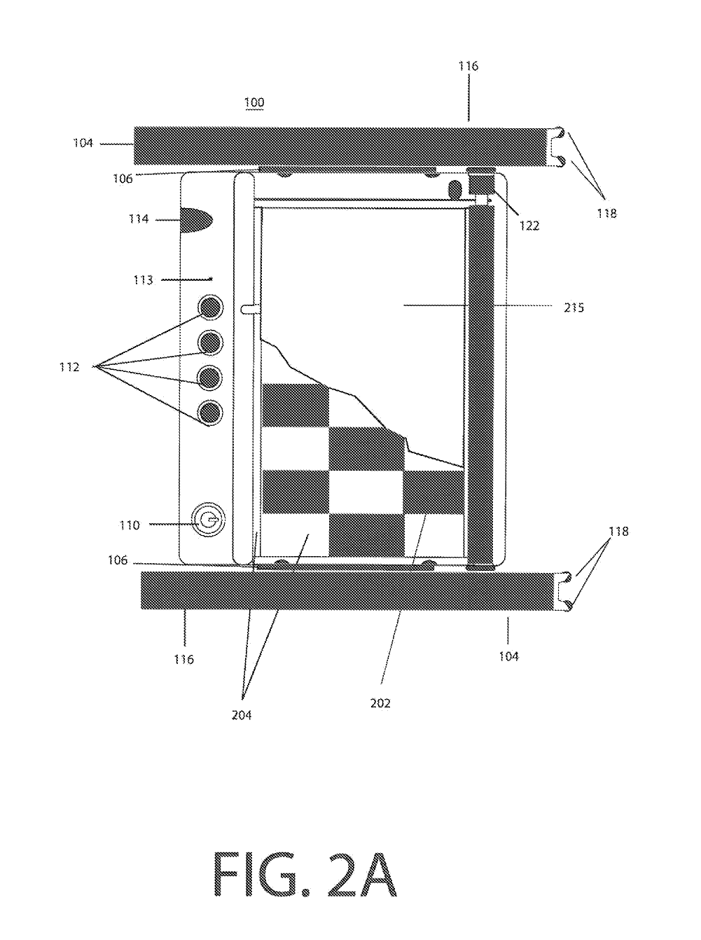

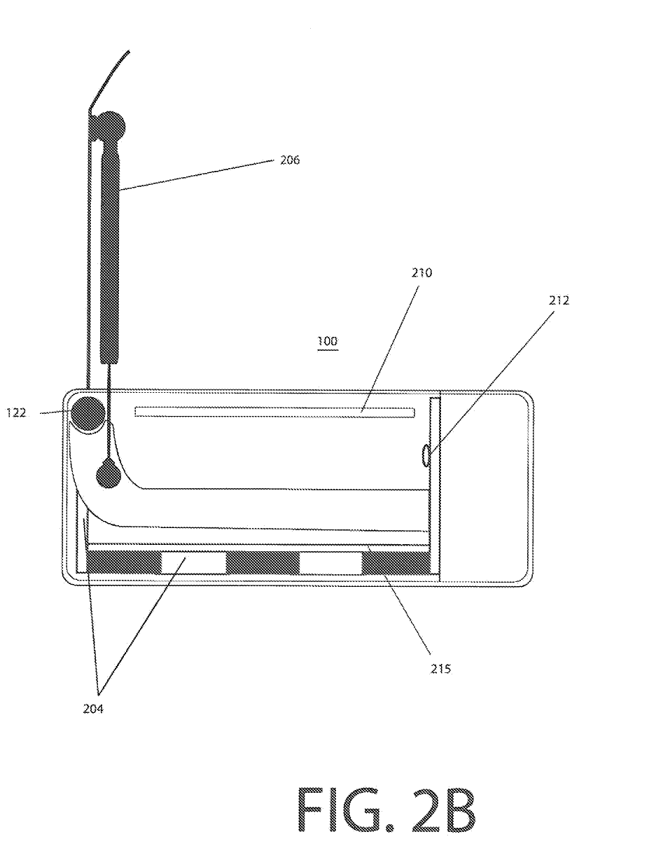

FIGS. 2A and 2B illustrate another view of the hidden safe system 100, according to various implementations. FIG. 2A illustrates front view of the hidden safe system 100 and the compartment 103. As illustrated in FIG. 2A, the compartment 103 can include a number of magnets 202. The magnets 202 can be utilized to secure metallic objects firearms, knives, etc.) to the back wall of the compartment 103. The magnets 202 can be arranged to maximize the magnetic profile of the magnets 202. For example, the magnets 202 can be arranged to interleave with a material 204 to form a “checkerboard” pattern. The material 204 can be any type of non-magnetic material, for example, foam, plastic, etc. While FIG. 2A illustrates an arrangement of the magnets 202, the magnets 202 can be arranged in any configuration to provide a magnetic surface on the back wall of the compartment 103.

Additionally, as illustrated in FIG. 2A, a material 215 can be placed over the surface of the magnets 204. The material 215 can be any type of material to cover the magnets 202. In some embodiments, for example, the material 215 can be felt to provide a non-abrasive surface for items to be secured by the magnets 202. In some embodiments, for example, the material 215 can be loop material.

FIG. 2B illustrates top view of the hidden safe system 100 and the compartment 103. As illustrated in FIG. 2B, a gas cylinder 206 can be attached to the safe 102 and the door 108. The gas cylinder 206 can be configured to provide a force to the door 108 to assist with the opening of the door 108. For example, when the door 108 is unlocked, the gas cylinder 206 can automatically open the door 108 with little or no force applied by the user of the safe. This allows the user to open the safe 102 easily, efficiently, and quickly by only having to unlock the safe 102. This allows the user to open the safe using only one hand.

In some implementations, as illustrated in FIG. 2B, the housing 120 of the safe 102 can include a channel 210. The channel 210 can be configured to receive an attachment device for attaching the bracket 106. In some implementations, the attachment device can move laterally along the channel 210. For example, the channel 210 can receive a bolt that can attach the bracket 106. The bolt can move laterally along the channel 210 until the bracket 106 is secured to the bolt by a nut. This allows the sliding rails 104 to be moved relative to the safe 102. As such, the sliding rails 104 can be positioned at different location relative to the safe 102.

In some implementations, as illustrated in FIG. 2B, the compartment 103 can include a light source 212, for example, a light emitting diode. The light source 212 can be configured to illuminate the interior of the compartment 103 when the door 108 is opened. The light source 212 can he activated in response to opening the door and/or interaction with the access systems.

In some implementations, the compartment 103 can include additional storage structures for holding items. For example, the compartment 103 can include shelves, pouches, boxes, and the like to hold items in the compartment 103. In some implementations, the additional storage structures can be attached to the housing 120. In some implementations, the additional storage structures can be metallic and secured to the safe 102 by the magnets 202. In some implementation, material, for example, hook material, can be attached to the additional storage structures and secured to the material 215, for example, loop material.

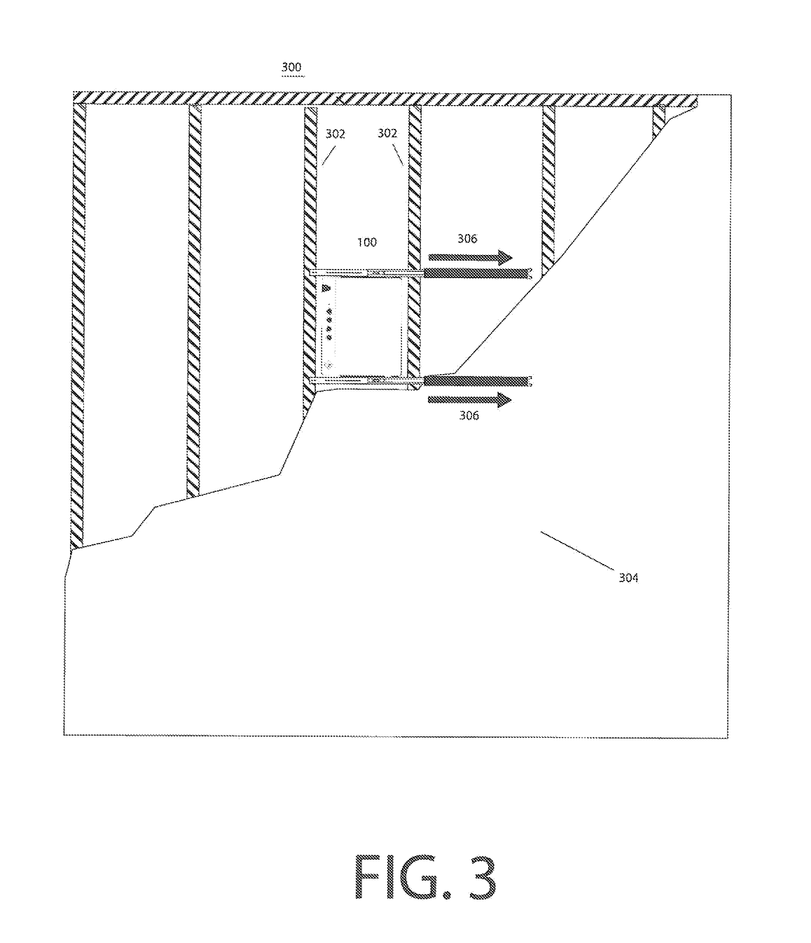

FIG. 3 illustrates a view of a wall 300 in which the hidden safe system 100 is installed, according to various implementations. As illustrated, the wall 300 can include one or more framing members 302 (e.g. studs). The framing members 302 can be covered with a covering material 304 (e.g. dry wall, plaster, etc.) In implementations, the hidden safe system 100 can be mounted to the wall 300. For example, the hidden safe system 100 can be mounted so that the safe 102 is positioned between the framing members 302 and the stationary arm 128 of the pair of sliding members 104 are secured to the framing members 302. When installed, the pair of sliding rails 104 can be positioned to be approximately flush with an outer surface of the covering material 304. As such, the front surface of the safe can be approximately flush with or recessed from the outer surface of the covering material 304. The safe 102 can be contained within the wall 300.

In operation, a user of the hidden safe system 100 can attach a covering (e.g. a painting, picture, etc.) to the pair of sliding member 104. When the hidden safe system 100 is not being accessed, the pair of sliding members 104 can be in the un-telescoped position so that the covering covers the hidden safe system 100. When viewing the wall 100, anyone without knowledge of the hidden safe system 100 may not realize that the hidden safe system 100 is present because the covering is positioned over the hidden safe system 100. As such, any item stored in the safe 102 may be protected from unwanted access. To gain access to the bidden safe system 100 and the safe 102, a user can apply a force to the covering and cause the pair of sliding arms 104 to move in the direction 306. Once open, the user can utilize the access systems to gain access to the items in the safe 202.

FIG. 3 illustrates the hidden safe system 100 being configured so that the pair of sliding arms 104 to move in the direction 306 that is horizontal (from left to right). In some implementations, the hidden safe system 100 can be configured so that the pair of sliding anus 104 to move in the direction 306 that is horizontal (from right to left). In some implantations, the hidden safe system 100 being configured so that the pair of sliding arms 104 to move in the direction 306 that is vertical (from up and down). For example, the pair of sliding arms 104 can be coupled to the sides of the safe 102.

In sonic implementations, the hidden safe system 100 can be provided with a template for installing the hidden safe system 100 in the wall 300. The template can provide a diagrams and instructions for that allow a user to easily install the hidden safe system 100. For example, the template can include a pattern that defines the outline of the safe 102 and locations of the opening 130. A user can place the template against the wall in order to mark the location on the wall at which to cut the covering material 304 and the location of the framing member 302.

While the teachings have been described with reference to examples of the implementations thereof, those skilled in the art will be able to make various modifications to the described implementations without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to he inclusive in a manner similar to the term “comprising.” As used herein, the terms “one or more of” and “at least one of” with respect to a listing of items such as, for example, A and B, means A alone, B alone, or A and B. Further, unless specified otherwise, the term “set” should be interpreted as “one or more.” Also, the term “couple” or “couples” is intended to mean either an indirect or direct connection. Thus, if a first device couples to a second device, that connection may be through a direct connection, or through an indirect connection via other devices, components, and connections.

1. A hidden safe system, comprising:
a safe, the safe comprising:
a housing forming a compartment,
a door coupled to the housing and configured to allow access to the compartment, and
an access system coupled to the housing and configured to unlock a locking mechanism;
a first rail coupled to a first side of the safe, a rear surface of the first rail being approximately flush with a front surface of the safe, the first rail comprising:
a first attachment device for coupling a covering to the first rail; and
a second rail coupled to a second side of the safe, opposite the first side, a rear surface of the second rail being approximately flush with the front surface of the safe, the second rail comprising:
a second attachment device for coupling the covering to the second rail,
wherein the first rail and the second rail are configured to move in a direction to position the covering over the front surface of the safe.

2. The hidden safe system of claim 1, the compartment comprising:
one or more magnets coupled to a back surface of the compartment; and
a first material covering the one or more magnets.

3. The hidden safe system of claim 2, wherein the one or more magnets are interleaved with a second material on the back surface of the compartment to form a checkerboard pattern.

4. The hidden safe system of claim 1, further comprising:
one or more storage structures coupled to an inner surface of the compartment.

5. The hidden safe system of claim 1, the first rail further comprising:
a first arm configured to be attached to a structure housing the hidden safe system; and
one or more telescoping arms coupled to the first arm, wherein the one or more telescoping arms move in the direction, parallel to the first arm, to position the covering over the front surface of the safe.

6. The hidden safe system of claim 5, the first arm comprising:
one or more openings configured to receive attachment devices to attach the hidden safe system to the structure housing the hidden safe system. (Original) The hidden safe system of claim 5, the first arm further comprising:
a locking mechanism configured to allow the one or more telescoping arms to be de-coupled from the first arm.

8. The hidden safe system of claim 1, wherein the first attachment device and the second attachment device comprise hook and loop material.

9. The hidden safe system of claim 1, wherein the access system comprise one or more of a lock and key, a key pad, and a biometric system.

10. A system for hiding a safe in a structure, the system comprising:
a first rail configured to be coupled to a first side of the safe so that a rear surface of the first rail is approximately flush with a front surface of the safe; and
a second rail coupled to a second side of the safe, opposite the first side, a rear surface of the second rail being approximately flush with the front surface of the safe,
wherein the first rail and second rail position the safe within the structure when the first rail and second rail are attached to the structure,
wherein the first rail and the second rail are configured to receive a covering, and
wherein the first rail and the second rail are configured to move in a direction to position the covering over the front surface of the safe.

11. The system of claim 10, wherein the first rail comprises a first attachment device for receiving the covering, wherein the second rail comprises a second attachment device for receiving the covering, and wherein the first attachment device and the second attachment device comprise hook and loop material.

12. The system of claim 10, the first rail further comprising:
a first arm configured to be attached to the structure housing the safe; and
one or more telescoping arms coupled to the first arm, wherein the one or more telescoping arms move in the direction, parallel to the first arm, to position the covering over the front surface of the safe.

13. The system of claim 12, the first arm comprising:
one or more openings configured to receive attachment devices to attach the hidden safe system to the structure housing the safe.

14. The system of claim 12, the first arm further comprising:
a locking mechanism configured to allow the one or more telescoping arms to be de-coupled from the first arm.

15. The system of claim 12, further comprising:
a bracket coupled to the first arm, wherein the bracket is configured to couple the first arm to the safe and allow the first arm to move relative to the safe.

16. A safe, comprising:
a housing forming a compartment;
a door coupled to housing and configured to allow access to the compartment;
an access system coupled to the housing and configured to unlock a locking mechanism;
one or more magnets coupled to a back surface of the compartment; and
a first material covering the one or more magnets.

17. The safe of claim 16, wherein the one or more magnets are interleaved with a second material on the back surface of the compartment to form a checkerboard pattern.

18. The safe of claim 16, further comprising:
a gas cylinder coupled to the door and the housing, wherein the gas cylinder is configured to apply force to the door when unlocked.

19. The safe of claim 16, further comprising:
a first bracket coupled to a first side of the housing, the first bracket configured to attach to a first rail; and
a second bracket coupled to a second side of the housing opposite the first side, the second bracket configured to attach to a second rail,
wherein the first rail and second rail position the safe within a structure when the first rail and second rail are attached to the structure,
wherein the first rail and the second rail are configured to receive a covering, and
wherein the first rail and the second rail are configured to move in a direction to position the covering over the front surface of the safe.

20. The safe of claim 16, wherein the first material is loop material.
